(19) United States
(12) Patent Application Publication
(10) Pub. No.: US 2010/0164746 A1
(43) Pub. Date: Jul. 1, 2010

(54) Toe-switch

(76) Inventor: Yigal Mesika, Los Angeles, CA (US)

Correspondence Address: Risso & Associates, 7350 West 85th Street, Los Angeles, CA, 90045, US

(21) Appl. No.: 12/660,795

(22) Filed: Mar. 4, 2010

Related U.S. Application Data
(63) Continuation-in-part of application No. 12/082,359, filed on Apr. 10, 2008.
Application No. 12/082,359 is a continuation-in-part of application No. 12/589,162, filed on Oct. 19, 2009.
Application No. 12/589,162 is a continuation-in-part of application No. 12/004,656, filed on Dec. 21, 2007.
(60) Provisional application No. 60/922,693, filed on Apr. 10, 2007.

(51) Int. Cl. G08C 19/16; H04L 17/02; H01H 35/02

(52) U.S. Cl. 340/825.69; 341/176; 200/61.52

(57) ABSTRACT

Described is a toe-switch for attaching with a user's toe and discretely operating a toe-switch operated device. The toe-switch includes a toe attachment, such as a Velcro band, that is formed to connect with a user's toe. A switching device, such as a tilt ball switch, is connected with the toe attachment. A toe-switch operated illusion device is communicatively connected with the switching device. Thus, a user can connect the toe attachment with the user's toe and operate the switching device with the toe, thereby discretely operating an electronic device that is operable via the toe-switch.

### PRIORITY CLAIM

This is a Continuation-in-Part Application of U.S. Non-Provisional application Ser. No. 12/082,359, filed on Apr. 10, 2008, entitled, “Concealable Electric Shock Device,” still pending, which is a non-provisional application of U.S. Provisional Application No. 60/922,693, filed on Apr. 10, 2007, entitled, “Electric Touch.” This application is ALSO a Continuation-in-Part application of U.S. Non-Provisional application Ser. No. 12/589,162, filed on Oct. 19, 2009, entitled, “Miniature Spool,” still pending. Finally, this application is ALSO a Continuation-in-Part application of U.S. Non-Provisional application Ser. No. 12/004,656, filed on Dec. 21, 2007, entitled “Miniature Spooling Apparatus,” still pending.

### BACKGROUND OF THE INVENTION

(1) Field of Invention

The present invention relates to props and gimmicks used in the field of magic to create a variety of illusions and, more particularly, to a concealable toe-switch for operating such props and gimmicks.

(2) Description of Related Art

The present invention relates to props and gimmicks used in the field of magic, carried on the person or hidden in the clothing of the magician, and used to create the illusion of controlling an object with no visible means to do so. Such props are commonly used to provide the illusion of levitation or other tricks, such as being “electrified.”

For example, the illusion of levitation can be performed using a product that is generally referred to as an invisible thread reel (ITR). There are typically two different types of ITR's available. A few motorized ITR's have been developed over the years that allow the user to seemingly control the motion of an object through magic. To provide an effective illusion, the magician needs to be able to control the device through hands-free operation.

With respect to being “electrified,” in order to discharge static electricity, a device is required that electrifies the user so that the static electricity is discharged when the user touches another person or object. However, as can be appreciated, it would be undesirable for a user to constantly be “electrified,” which would likely result in unintentional electrical discharges. Thus, again, it is desirable for the magician to be able to selectively activate the device without giving away the device's location or operation.

To accommodate the need to conceal the operation of such devices, magicians in the past have conceived toe-switches. Thus, using the toe-switch, a magician can conceal the operation of such props and devices within the magician's shoe. Toe-switches were first introduced in approximately 1985 in a product called FISM Flash, by John Cornelius. FISM Flash was a product which produced a burst of light that was triggered using a toe-switch. The original toe-switch (included with the FISM Flash product) was formed to include a switch that was secured under the user's big toe. Upon pressing down the user's big toe and sandwiching the toe-switch between the toe and inner sole of a shoe, the toe-switch was activated to operate the FISM Flash. A problem with the original toe-switch was the placement of the device. More specifically, because it was secured under the user's big toe, the toe-switch was prone to damage while a user walked (with the toe-switch secured to the user's big toe). As such, a problem with existing toe-switches is that they must be worn under the user's toe, thereby damaging the unit when worn and walking simultaneously.

Thus, a continuing need exists for concealable toe-switch that is not positioned under a user's big toe, yet is worn in such a manner to allow a user to selectively control a device while concealed within the shoe of a user.

### SUMMARY OF INVENTION

The present invention relates to props and gimmicks used in the field of magic to create a variety of illusions and, more particularly, to a concealable toe-switch for discretely operating such props and gimmicks.

The toe-switch includes a toe attachment, such as a Velcro band, that is formed to connect with a user's toe. A switching device, such as a tilt ball switch, is connected with the toe attachment. A toe-switch operated illusion device is communicatively connected with the switching device. Thus, a user can connect the toe attachment with the user's toe and operate the switching device with the toe, thereby discretely operating an electronic device that is operable via the toe-switch.

Finally, as can be appreciated by one in the art, the present invention also comprises a method for forming and using the toe-switch described herein.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is an illustration of a concealable electric shock device that is suitable for use with a toe-switch according to the present invention, depicting an interior of a housing of the electric shock device;

FIG. 2 is an illustration of the concealable electric shock device, depicting the concealable electric shock device as being attached with a user's leg;

FIG. 3 is an illustration of a user using static electricity to bend a stream of water;

FIG. 4 is an illustration of an invisible thread reel device that is suitable for use with the toe-switch of the present invention;

FIG. 5 is an illustration of a toe-switch according to the present invention;

FIG. 6A is an illustration of a first-side of a toe-switch according to the present invention;

FIG. 6B is an illustration of a second-side of a toe-switch according to the present invention;

FIG. 7 is an illustration of a toe-switch being wrapped around to form a band that can be wrapped around a user's toe;

FIG. 8 is an illustration of a toe-switch and the corresponding wireless transmitter;

FIG. 9 is an illustration of a user's foot, with the wireless transmitter tucked within the user's sock; and

FIG. 10 is an illustration of a user's foot, with the toe-switch wrapped around the user's toe.

### DETAILED DESCRIPTION

The present invention relates to props and gimmicks used in the field of magic to create a variety of illusions and, more particularly, to a concealable toe-switch for operating such props and gimmicks. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is only one example of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Please note, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object.

(1) Description

The present invention relates to a concealable toe-switch for operating props that are used in the field of magic or other fields in which it may desirable to attach a switch device with a user's toe. Such props are commonly electronic devices that require an operator to control the device. Thus, the present invention is a toe-switch that can be used to discretely control the operation of an electronic device. It should be understood that although the present invention is described as being used in the field of magic, the present invention is not intended to be limited thereto as it can be used for any electronically controlled device.

Before describing the present invention in detail, two suitable devices (i.e., toe-switch operated, illusion devices) that can be selectively operated with the toe-switch are first described to provide the reader with a better understanding of suitable applications of the present invention. Again, it should be understood that the example devices described below are for illustrative purposes only as the present invention is not intended to be limited thereto and can be applied to a myriad of devices.

(1.1) Concealable Electronic Device (i.e., “Electric Touch”)

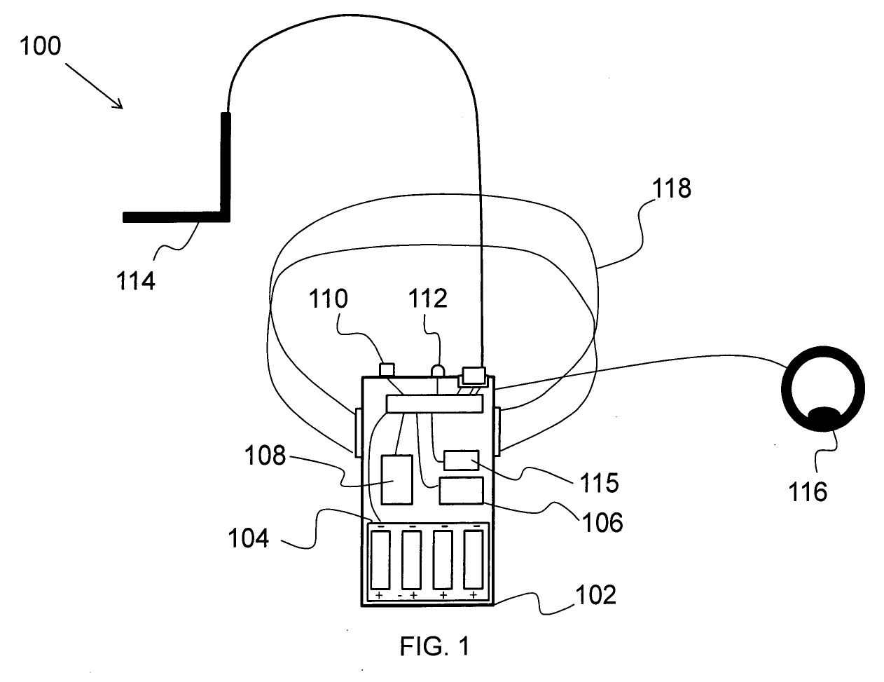

As shown in FIG. 1, the toe-switch of the present invention can be used with a toe-switch operated illusion device. In this example, the toe-switch operated illusion device is a concealable electric shock device 100 that generates static electricity across a user's body. Such a device is sold by the inventor of the present application and is commonly referred to as the “Electric Touch.” The static electricity can be used for moving small, oppositely charged items, for educational or entertainment purposes, or for discharging static electricity between the wearer's body and the person or object that is being touched. Thus, the electric shock device 100 can be used to provide a shock for entertainment, educational means, personal protection, or for therapeutic remedy.

The electric shock device 100 is capable of producing a high-voltage charge at a low-amperage rating across the body to form a static charge that can be utilized for a wide variety of uses (as mentioned above). This charge uses the body to attract other objects with dissimilar charges, or can be used to discharge the energy through contact with a person, or object that it grounded.

In operation, the electric shock device 100 generates a high-voltage alternating current (AC) charge from a low-voltage direct current (DC) source (e.g., 12 volt DC). The electric shock device 100 includes a housing 102 (depicted as being open for illustrative purposes) which houses the DC power source 104. Also included is a DC-to-AC power inverter 106. The DC-to-AC power inverter 106 for converting the DC current into conventional AC electricity. Following the DC-to-AC power inverter 106 is a voltage multiplier 108 that is capable of multiplying the AC voltage to a high-voltage low-current output (e.g., approximately 12 kV). Thus, the voltage multiplier 108 includes a series of capacitors and diodes that are connected to the output of the DC-to-AC power inverter 106 to multiply the AC voltage.

Also included with the electric shock device 100 are a primary on/off switch 110 and power indicator 112. The primary on/off switch 110 is any suitable mechanism or device that is capable of allowing a user to selectively turn on and off the electric shock device 100, a non-limiting example of which includes a slide switch. Further, a power indicator 112 can be used to alert a user to whether or not the electric shock device 100 is on (e.g., light-emitting diode (LED)).

The electric shock device 100 also includes an external ground 114. The external ground 114 is any suitably mechanism or device that allows the electric shock device 100 to be in contact with a ground (e.g., floor) surface and thereby ground the electric shock device 100, a non-limiting example of which includes an electrically conductive material (e.g., metal) that is electrically connected with the voltage multiple 108. In one aspect, the external ground 114 is an “L-shaped” piece of copper that can be fitted to the sole of a user's shoe.

Also included is a secondary on/off switch 116. The secondary on/off switch 116 allows a user to selectively and secretly activate the electric shock device 100. In other words, while performing a trick or otherwise operating the electric shock device 100, it may be desirable to allow the user to turn on the electric shock device 100 while not alerting an audience. Thus, in order to for the electric shock device 100 to work, both the primary on/off switch 110 AND the secondary on/off switch 116 must be activated (i.e., on position). The secondary on/off switch 116 is any suitable mechanism or device that is capable of allowing a user to selectively turn on and off the electric shock device 100, a non-limiting example of which includes a toe-switch according to the present invention. The toe-switch is a switch that attaches with the user's toe and can be activated by using the toe to depress a button on the toe-switch.

As noted above, while using the electric shock device 100, it is desirable to conceal the device so as not to alert an audience that the magician, etc., is using some form of an electric device to generate the shock effect. Thus, the electric shock device 100 includes an attachment mechanism 118. The attachment mechanism 118 is any suitable mechanism or device that allows the electric shock device 100 to be attached with a user's body, a non-limiting example of which includes an elastic strap.

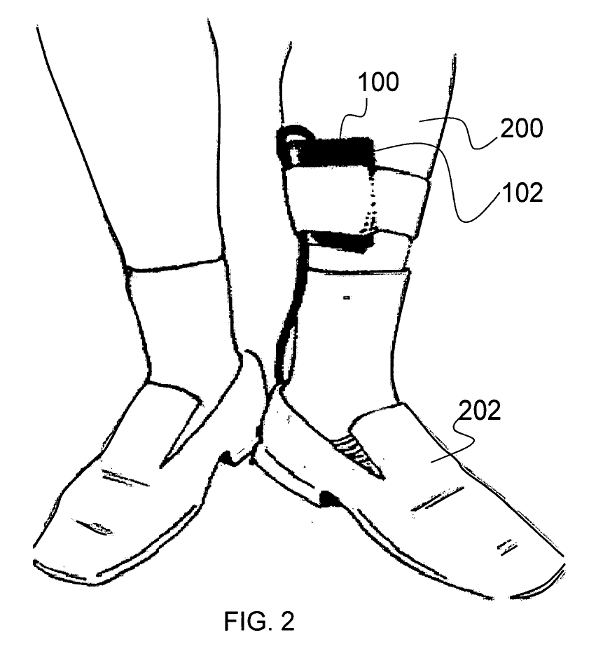

For example and as illustrated in FIG. 2, the electric shock device 100 can be affixed with a user's leg 200, while the external ground (not shown) is affixed with the user's first shoe 202 and thereby grounded. When the toe-switch is activated, the electric shock device 100 is activated to “electrify” the user.

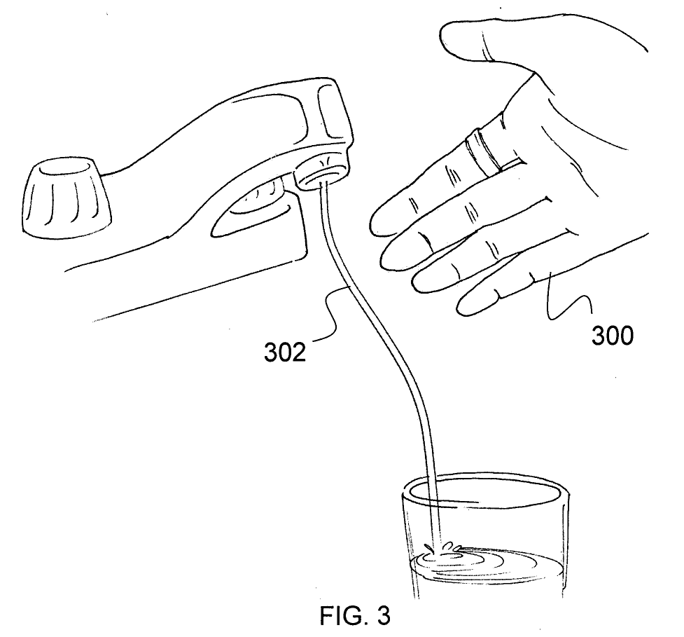

As noted above, when both the primary on/off switch AND the secondary on/off switch (e.g., toe-switch) are activated, a current is passed through a user-side electrical contact into the user. The charge can be passed directly to an audience member, thereby shocking them. However, as can be appreciated by one skilled in the art, the charge also creates static electricity within the user which can be used for other effects, such as moving small objects (e.g., paper shavings) or bending water. As shown in FIG. 3, when “electrified,” the user can place their hand 300 or other body part near a stream of water 302, which, through the static electricity, actually causes the stream of water 302 to bend. Thus, the secret control of the electric shock device through use of the toe-switch can be used to provide a variety of effects.

(1.2) Miniature Spooling Apparatus (i.e., “Spider Pen Pro”)

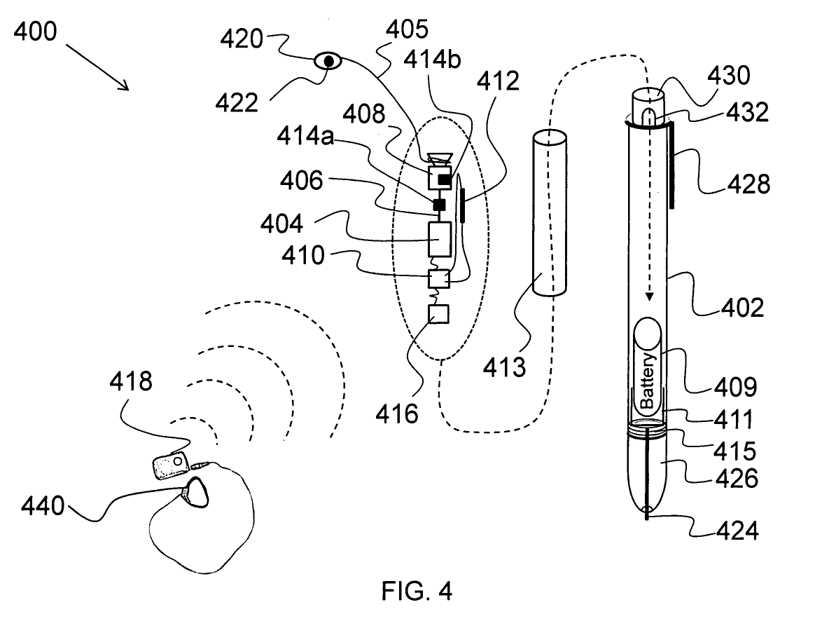

As shown in FIG. 4, the toe-switch according to the present invention can be used to operate a miniature spooling apparatus 400. Such a device is sold by the inventor of the present invention and is commonly referred to as the “Spider Pen Pro.” The miniature spooling apparatus 400 includes a housing 402 having a miniature motor 404 attached with the housing 402 for spinning a thread 405 (e.g., invisible or micro-thread) around a thread spooler. The motor 404 also provide a constant and even amount of tension when in operation.

The motor 404 includes an axle 406 extending there from, with a mechanically powered miniature spool 408 attached with the axle 406. Thus, the motor 404 is connected with the miniature spool 408 for powering the miniature spool 408 and winding thread 405 around the miniature spool 408. Rotational torque from the motor 404 is transferred through the miniature spool 408 and into the thread 405 in the form of a continuous pulling force. The constant and even tension created in the thread 405 is vastly superior to operational parameters offered by any previous non-motorized devices. It should be noted that as the motor 404 attempts to reel in the thread 405, the user can pull against the motor 404 while the motor 404 is still turned on and actually pull thread 405 out against the motor's pulling force. Thus, as the user pulls the thread 405 out and the motor 404 attempts to reel in the thread 405, the thread is taut which provides a constant tension.

An integrated circuit 410 is electrically connected with the motor 404 to operate the motor 404. The integrated circuit 410 is housed within the housing 402 and is configured to start and stop the motor 404 (i.e., turn the motor off and on). The integrated circuit 410 is, for example, an integrated circuit that includes a memory and is capable of sending a start and stop signal to the motor 404. The integrated circuit 410 can include a pre-programmed memory, or be programmable such that a user can program their own commands into the integrated circuit 410. Although described as an integrated circuit 410, as can be appreciated by one skilled in the art, the component can be replace with any suitable mechanism or device capable of performing the same functions listed herein.

A power source 409 is attached with the housing 402 and electrically connected with both the integrated circuit 410 and motor 404 to power the motor 404. The power source 409 is any suitable source of energy that is operable for powering the motor 404. As a non-limiting example, the power source 409 is a 1.5 Volt battery that is encased within the housing 402. Also included is a battery holder 411. The battery holder 411 is positioned within the housing 402 operates to hold the power source 409 fixed in place within the housing 402.

A switch 412 is electrically connected with the integrated circuit 410 to send a signal (e.g., complete a circuit) to the integrated circuit 410. Upon receipt of the signal, the integrated circuit 410 either starts or stops the motor 404, depending upon the motor's 404 current operation. The switch 412 is any suitable switch that is capable of completing a circuit or otherwise sending a signal to an integrated circuit 410. As a non-limiting example, the switch 412 is a magnetic reed switch that is operable via a magnetic field. Other non-limiting examples of suitable switches include a timer mechanism and a motion activated switch. For example, if a motion activated switch, upon the user's body motion, the integrated circuit 410 will cause the motor 404 to turn on for a predetermined amount of time (or until the motion stops).

As noted above, in a desirable aspect, the switch 412 is a magnet reed switch that is electrically connected with the integrated circuit 410. To operate the switch 412, a magnet 414a and/or 414b is attached with the axle 406 and/or the miniature spool 408. As a non-limiting example, the magnet 414a can be wrapped around the axle 406, with the axle 406 positioned through the magnet 414a. As another non-limiting example, the magnet 414b is embedded within the miniature spool 408. Thus, as a user manually pulls the thread 405 from the miniature spool 408, this causes both the axle 406 and miniature spool 408 to rotate, which in turn rotates the magnet 414b. The magnetic reed switch 412 is attached within the housing 402 such that it is positioned proximate the magnet 414a and/or 414b.

The integrated circuit 410 can also be configured such that as the thread 405 is pulled slowly by the user, the motor 404 will remain off. However, as the user manually pulls the thread 405 at an increased speed, the integrated circuit 410 then turns on the motor 404. An advantage to this is that it allows a user to withdraw thread 405 while not causing the motor 404 to turn on. This effect can be caused by a program within the integrated circuit 410, or by the properties of the magnetic reed switch 412.

After the motor 404 has wound the thread 405 onto the miniature spool 408, the miniature spool 408 longer rotates and is in a freeze pattern (is still). After being still for a predetermined amount of time, the integrated circuit 410 then turns off the motor 404. As a non-limiting example, after the miniature spool 408 (and thereby the motor 404) stops spinning for about five seconds, the integrated circuit 410 turns the motor 404 off.

Alternatively, integrated circuit 410 is configured to determine when and if the thread 405 breaks. When the thread 405 breaks, the motor 404 spins freely without any counter-pulling tension as provided by the user. Thus, when the motor 404 is rotating freely without any counter tension for a predetermined amount of time, the integrated circuit 410 is configured to turn the motor 404 off As a non-limiting example, after the motor 404 has rotated freely for seven seconds, the integrated circuit 410 turns the motor off.

In another aspect, the apparatus 400 includes an internal housing 413. The internal housing 413 allows the motor 404, integrated circuit 410, and other components (e.g., receiver 416 described below) to be safely and tightly held within a single unit (i.e., the internal housing 413). In this aspect, the internal housing 413 with its components therein are then fit into the housing 402 to provide a secure and tight fit. The use of the internal housing 413 also assists in mass production as it results in a compact, single unit that can be easily incorporated into other units.

One skilled in the art can appreciate that the miniature spooling apparatus 400 can be operated remotely using a variety of devices. For example, the apparatus 400 can include a wireless receiver 416 that is attached with the integrated circuit 410 for receiving a signal form a wireless transmitter 418. Thus, the integrated circuit 410 is configured to receive the signal from the wireless transmitter 418 and cause the motor 404 to turn on and/or off, thereby allowing a user to remotely control the miniature spooling apparatus 400. The wireless transmitter 418 can include an attachment means to allow the transmitter 418 to be secretly attached with different locations on the user's body, thereby concealing the item and allowing a user to secretly use the transmitter 418. For example, the transmitter 418 can include a small magnet, Velcro, or any other attachment means that allows the transmitter 418 to be attached with the user.

The toe-switch 440 of the present invention can be used to activate the transmitter 418. For example, a remote-control toe-switch 440 is a switch that attaches with the user's toe and can be activated by using the toe to depress a button on the toe-switch 440. In other words, the remote control transmitter 418 can be attached with the user's sock, calf, or otherwise concealed near the user's feet. The transmitter 418, in this aspect, is then wired to the toe-switch 440 that is operated by a ball switch (or button). For example, there is a uniform piece of plastic with a piece of rubber that loops around the user's toe. Either positioned above or below the user's toe is the actual toe-switch 440. Thus, once the user bends the toe, the switch 440 is actuated to send the signal to the transmitter 418, which then sends the signal to the receiver 416, which then activates the motor 404.

It should also be understood by one skilled in the art that the toe-switch 440 can be directly wired to a device (e.g., miniature spooling apparatus 100) without the need for a wireless transmitter 418, etc.

(1.3) Toe-Switch (i.e., “Mesika Remote with Mesika Toe-Switch”)

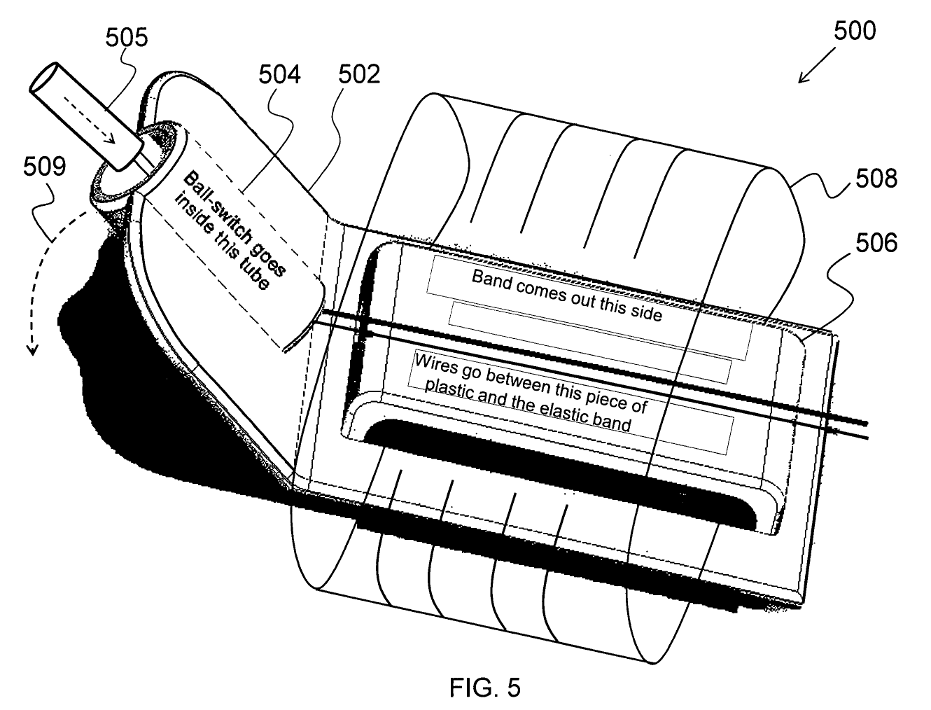

As mentioned throughout, the present invention is directed to a toe-switch that can be used to operate a variety of electrically powered devices. For further illustration, FIG. 5 depicts an example of a toe-switch 500 according to the present invention, which can be referred to as the “Mesika Toe-Switch.” The toe-switch 500 (i.e., Mesika Toe-Switch) is essentially a concealable switch device that is operated by a user's toe by being attached to the toe. More specifically, in this non-limiting example, the toe-switch includes a frame 502 (e.g., angled frame) for placement of a suitable switching device 505 (e.g., tilt switch or ball switch) therein or attached therewith. As can be appreciated by one skilled in the art, any suitable switching device 505 can be used, a non-limiting example of which includes a tilt ball switch, which is a switch that can detect basic motion/orientation. A tilt ball switch includes a metal tube with a little metal ball that rolls around in it, when it is tilted upright, the ball rolls onto the contacts sticking out of the end and shorts them together. As another non-limiting example, the frame 502 can include a hollow portion 504 (e.g., tube) to allow placement of the switching device 505 within the hollow portion 504.

In yet another non-limiting example, a standard push-button switch can be positioned within the hollow portion 504 (with the hollow portion 504 being a compressible tube), such that compressing the tube depresses the push-button switch to activate/deactivate the attached device.

The frame 502 also includes a strap attachment 506 that allows for connection of a toe attachment 508 (e.g., elastic band or Velcro band) thereto. Thus, as depicted, the toe attachment 508 forms a loop that can be positioned around the user's toe. Once attached with the user's toe, by depressing the attachment hollow portion, the hollow portion 504 is bent 509 which activates the switching device 505, thereby allowing the toe-switch 500 to control any of the said components that may be attached thereto. In this example, although illustrated in the reverse, the frame 502 can be positioned above the toe, such that the hollow portion 504 is bent 509 upwards to cause the ball to roll to the end of the switching device 505. Alternatively, it can be appreciated that the example depicted in FIG. 5 can be worn beneath the toe, allowing a user to bend 509 the hollow potion 504 downward.

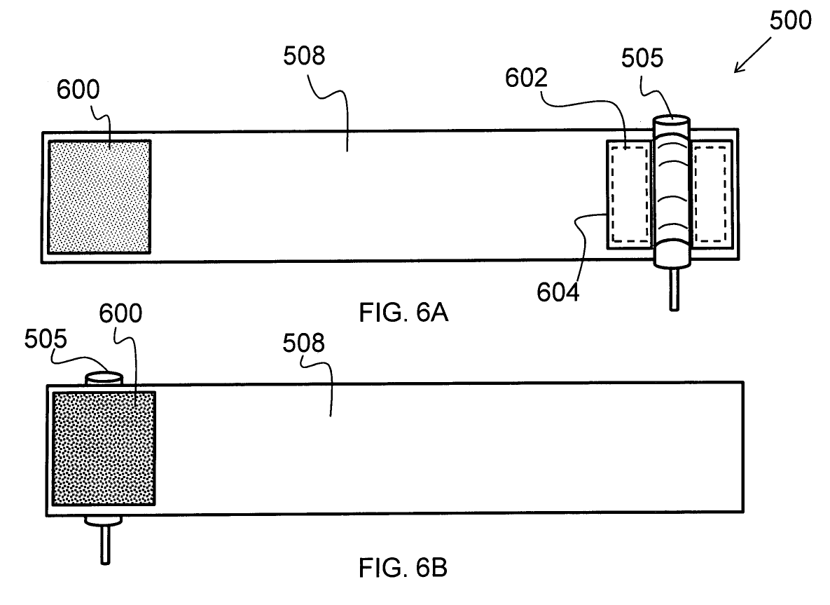

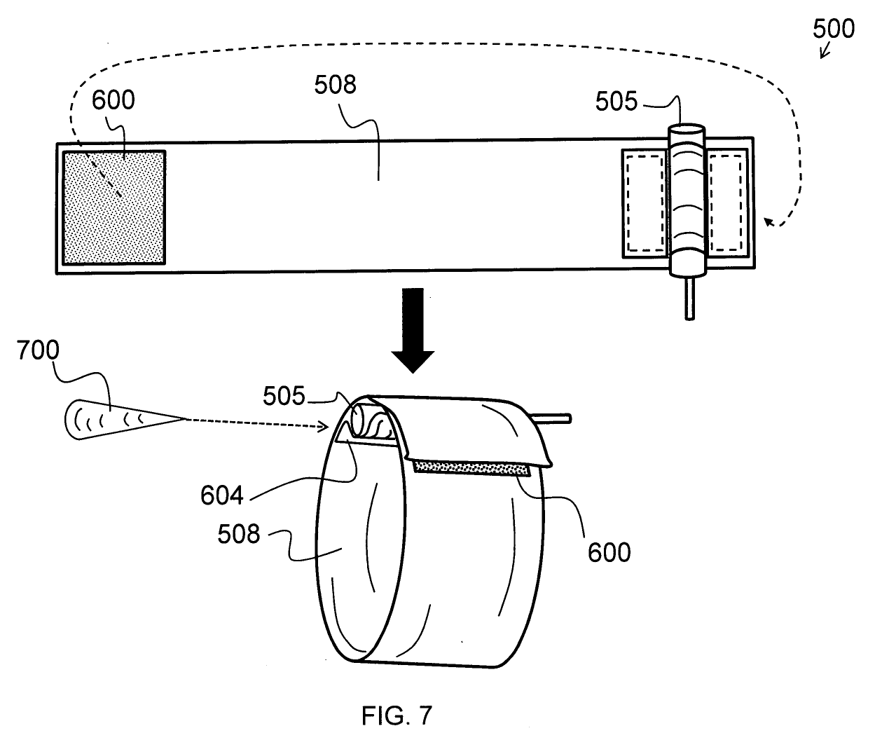

For additional understanding, the toe switch 500 is further illustrated in FIGS. 6A through 7. As can be appreciated by one skilled in the art, although the toe-switch 500 is depicted in FIG. 5 as having an angled frame and hollow portion, the present invention is not intended to be limited thereto and can be formed as depicted in FIGS. 6A through 7 (or in other suitable configurations). For example, FIG. 6A depicts a first-side of the toe-switch 500 while FIG. 6B depicts a second-side of the toe-switch 500. As shown in FIG. 6A, the toe-switch 500 includes a toe attachment 508 for attaching with a user's toe. In this example, the toe attachment 508 is a Velcro backed or elastic band. In the event of a Velcro backed band, hook and loop fasteners 600 are used and appropriately positioned on corresponding portions of the band.

In this example, the switching device 505 can be sewn 602 onto the toe attachment 508 by sandwiching the switching device 505 between the toe attachment 508 and a frame 502 (e.g. which is a cloth or plastic patch 604 in this example). Thus, the frame 502 is sewn against the toe attachment 508, with the switching device 505 sandwiched therebetween. As can be appreciated by one skilled in the art, the technique for attaching the switching device 505 with the toe attachment 508 is but one non-limiting example, as there are numerous ways for attaching such a switching device to a toe attachment.

For further understanding, FIG. 7 depicts the toe-switch 500 and the toe attachment 508 being wrapped around and attached with itself (via the hook and loop fasteners 600). Also shown is the switching device 500, which can be attached with the user's toe such that it is positioned on top of the toe (e.g., over the toe nail).

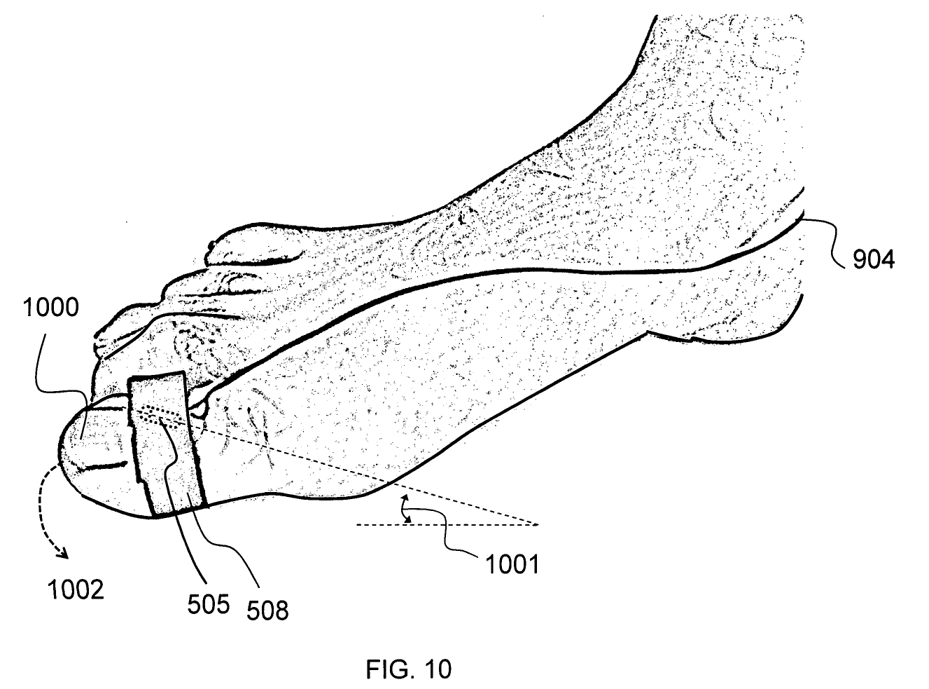

Also depicted in FIG. 7 is a wedge-shaped device 700 that can be positioned within the toe-switch 500. The wedge-shaped device 700 is any suitable mechanism or device that can provide an angle to the switching device 505 when worn by a user. As a non-limiting example, the wedge-shaped device 700 is a cone-shaped piece of plastic that is positioned between the frame (e.g., plastic patch 604) and the toe attachment 508 when the two are connected with one another. For example, the wedge-shaped device 700 is positioned between the switching device 505 and the plastic patch 604. Thus, and as depicted in FIG. 10, when the toe-switch 500 is positioned upon a user's toe, the wedge-shaped device 700 is attached with the toe-switch 500 such that it is proximate the switching device 505 to cause the switching device 505 to rest at an upward angle 1001.

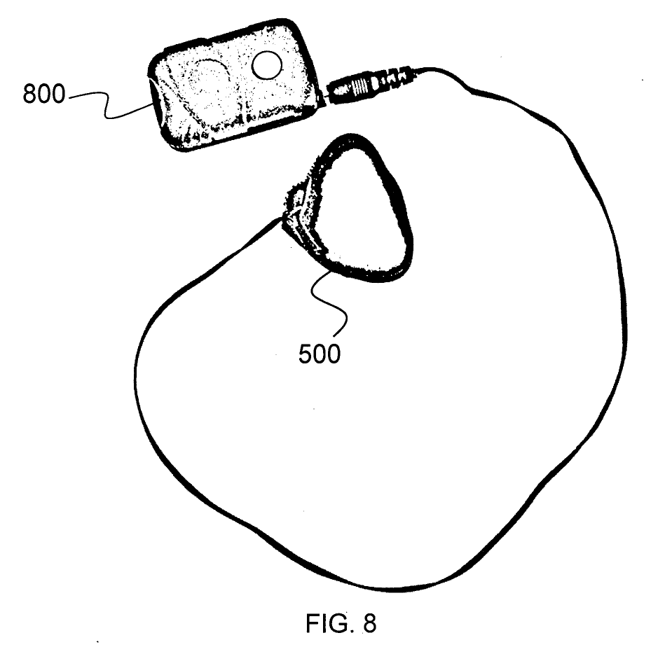

As shown in FIG. 8, the toe-switch 500 can be connected with a wireless transmitter 800 (also depicted as element 418 in FIG. 4) for wirelessly controlling an electrical device. Thus, the toe-switch 500 connected with the wireless transmitter 800 forms a product entitled, the “Mesika Remote.”

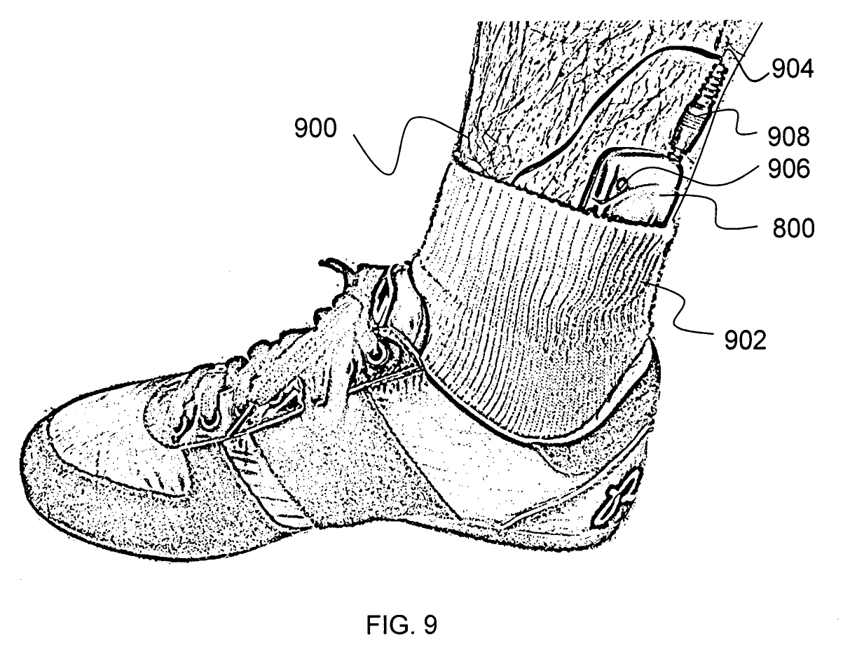

As shown in FIG. 9, in operation, the transmitter 800 can be attached around a user's ankle 900 by means of a strap or by placing it in the user's sock 902. A toe-switch wire 904 of the toe-switch can then be plugged into the transmitter 800 via a jack 908 that terminates at the end of the toe-switch wire 904. The jack 908 is formed to selectively attach/detach with a corresponding jack on the transmitter 800. Alternatively, the toe-switch wire 904 can be hard wired into the transmitter 800.

As shown in FIG. 10, the toe-switch wire 904 will run down the remainder of the user's ankle and to one of their toes (e.g., big toe 1000). It will then be attached by wrapping the toe attachment 508 (e.g., strap) around the user's big toe 1000, using the hook and loop fasters to keep the toe attachment 508 tight. On top of the toe 1000 now sits the switching device 505. When the big toe 1000 is bent down 1002, it causes the switching device 505 to activate such that it will send a signal to the transmitter to activate the applicable device. As can be understood by one skilled in the art, the toe switch can be formed such that the switching device 505 is reversed. In other words, if the switching device 505 is reversed (while still positioned on top of the toe), the switching device 505 would complete the circuit when the toe is bent up (as opposed to being bent down as illustrated). This reverse configuration would be due to the formation of the switching device 505 itself, or due to the positioning of the switching device with respect to the toe attachment 508. For example, as illustrated in FIG. 10, the switching device 505 is positioned within the toe attachment 508 such that a starting point (and un-activating point) of the switching device 505 is at an upward angle 1001. In the reverse configuration, the switching device 505 could be turned around and attached with the toe attachment 508 such that it begins at a downward angle. Thus, in the reverse configuration, a user would lift the big toe to cause the switching device 505 to complete the circuit and activate an attached device.

To further assist a user, a light (depicted as element 906 in FIG. 9) can be included on the transmitter 800 that will illuminate every time the transmitter 800 is sending a signal. Although the transmitter can operate to send a single on/off signal, the present invention is not limited thereto. For example, the transmitter 800 can have the capability of sending sequential signals (e.g., signal after signal), making it a multi-function transmitter when used with a receiving device that is configured to perform a different action up receipt of each signal.

As another example, the transmitter 800 can include a processor and corresponding signal hardware to send a variety of signals upon receipt of various commands from the switching device. For example, upon activating the switching device for a first amount of time (or according to a first activation pattern), the transmitter 800 sends a first signal. Further, upon activating the switching device for a second amount of time (or according to a second activation pattern), the transmitter 800 sends a second signal, etc. Thus, the transmitter 800 can send distinct wireless signals to a receiving device (e.g., Spider Pen Pro) upon receiving distinct command signals (e.g., various timed activation signals or patterns) from the switching device. Thus, the receiving device (e.g., the toe-switch operated illusion device, such as the Spider Pen Pro) is formed to perform distinct commands upon receipt of each of the distinct wireless signals from the transmitter.

For further illustration of such an application, the toe-switch can be used as a wireless TV remote control, with the transmitter formed to send a distinct command signal upon each distinct signal pattern/time/etc. from the toe-switch. As a non-limiting example, a user can bend down the toe for 2 seconds, which causes the transmitter 800 (which in this example, is formed as a universal RF remote control that can be programmed for a particular TV) to send an ON signal to the TV. If the user bends down the toe for 4 seconds, a VOLUME UP command is sent. If the user bends down the toe for 6 seconds, a VOLUME DOWN command is sent. If the user bends down the toe for 8 seconds, an OFF signal is sent to the TV. Thus, as can be appreciated by one skilled in the art, the present invention can be used to control a variety of electronic devices and, further, the transmitter can be formed to send a distinct command signal (that is received and interpreted by a receiver on a receiving device) to causing a receiving device to perform multiple and distinct functions.

Thus, in summary, the present invention is directed to a toe-switch that can be concealed within a user's shoe or footwear to allow the user to operate a device through a hands free operation. Because the switching device 505 is positioned on top of the toe and only has a small strap of Velcro around the toe, the user barely feels the toe-switch 500 while walking. Further, because the switching device 505 is positioned on top of the toe 1000, there is no harm to the device while walking.

What is claimed is:

1. A toe-switch for attaching with a user's toe and discretely operating a toe-switch operated device, the toe-switch comprising:
a toe attachment, the toe attachment formed to connect with a user's toe; and
a switching device connected with the toe attachment, whereby a user can connect the toe attachment with the user's toe and operate the switching device with the toe, thereby operating an electronic device that is operable via the toe-switch.

2. The toe-switch as set forth in claim 1, wherein the toe attachment is a band with hook and loop fasteners.

3. The toe-switch as set forth in claim 2, wherein the switching device is a tilt ball switch.

4. The toe-switch as set forth in claim 3, further comprising a wireless transmitter electrically connected with the switching device.

5. The toe-switch as set forth in claim 4, further comprising a toe-switch operated illusion device for receiving operating signals from the switching device.

6. The toe-switch as set forth in claim 5, wherein the toe-switch operated illusion device includes a receiver for receiving signals from the wireless transmitter.

7. The toe-switch as set forth in claim 6, wherein the transmitter includes a processor and is configured to generate distinct wireless signals upon receiving distinct command signals from the switching device.

8. The toe-switch as set forth in claim 7, wherein the toe-switch operated illusion device is formed to perform distinct commands upon receipt of each of the distinct wireless signals from the transmitter.

9. The toe-switch as set forth in claim 8, further comprising a wedge-shaped device that is attached with the toe-switch and proximate the switching device such that when the toe-switch is positioned upon a user's toe, the wedge-shaped device causes the switching device to rest at an upward angle.

10. The toe-switch as set forth in claim 1, wherein the switching device is a tilt ball switch.

11. The toe-switch as set forth in claim 1, further comprising a wireless transmitter electrically connected with the switching device.

12. The toe-switch as set forth in claim 1, further comprising a toe-switch operated illusion device for receiving operating signals from the switching device.

13. The toe-switch as set forth in claim 1, further comprising:
a wireless transmitter electrically connected with the switching device; and
a toe-switch operated illusion device for receiving operating signals from the switching device, wherein the toe-switch operated illusion device includes a receiver for receiving signals from the wireless transmitter.

14. The toe-switch as set forth in claim 13, wherein the transmitter includes a processor and is configured to generate distinct wireless signals upon receiving distinct command signals from the switching device.

15. The toe-switch as set forth in claim 14, wherein the toe-switch operated illusion device is formed to perform distinct commands upon receipt of each of the distinct wireless signals from the transmitter.

16. The toe-switch as set forth in claim 1, further comprising a wedge-shaped device that is attached with the toe-switch and proximate the switching device such that when the toe-switch is positioned upon a user's toe, the wedge-shaped device causes the switching device to rest at an upward angle.

17. A method for performing an illusion using a toe-switch, the method comprising acts of:
attaching a toe-switch around a user's toe, the toe switch having a toe attachment formed to connect with a user's toe and a switching device connected with the toe attachment, wherein the toe-switch is attached with the user's toe such that the switching device is positioned on top of the user's toe;
controlling a toe-switch operated illusion device through actuation of the toe-switch.
